(19) United States
(12) Patent Application Publication
(10) Pub. No.: US 2025/0135996 A1
(43) Pub. Date: May 1, 2025

(54) VEHICULAR HOLOGRAM APPARATUS

(71) Applicant: Saul Alejandro Leal, Saratoga Springs, UT (US)

(72) Inventor: Saul Alejandro Leal, Saratoga Springs, UT (US)

(21) Appl. No.: 18/496,174

(22) Filed: Oct. 27, 2023

(51) Int. Cl. B60R 1/00; B60K 35/00

(52) U.S. Cl. CPC B60R 1/001; B60K 35/00; B60K 35/60; B60K 35/81; B60K 2360/21; B60K 2360/29; B60K 2360/785; B60R 2300/302; B60Y 2200/112; B60Y 2400/3017

(57) ABSTRACT

An apparatus can include a hologram device, a vehicle mount attachable to the hologram device, and a power supply in electrical communication with the hologram device. In some examples, the vehicle mount includes a suction cup configured to engage a vehicle window. In certain examples, the suction cup is a first suction cup positionable on a first lateral side of the hologram device, and the vehicle mount further includes: a second suction cup positionable on a second lateral side of the hologram device opposite the first lateral side; and a support bar extending between the first suction cup and the second suction cup and connected to the hologram device. In specific examples, the vehicle mount includes a stand mountable to a vehicle support surface. In another example, the vehicle mount includes a vehicle frame mount to suspend the hologram device from a vehicle frame adjacent to a vehicle window.

### FIELD

The described examples relate generally to hologram devices. In particular examples, the disclosure relates to a vehicular hologram apparatus.

### BACKGROUND

Hologram devices can be utilized to display various types of content. Indeed, conventional hologram devices can include an on-board library of available content to display, including animations, videos, or images. Some of the content can depict objects with realistic or levitation effects to simulate a three-dimensional display. In some cases, the content can be customized. However, conventional hologram devices have limited use and benefit, largely because conventional hologram devices can be considered “dumb” devices. Specifically, most conventional hologram devices display content in an unintelligent fashion by playing preprogrammed content on loop (e.g., via a SIM card) or in response to direct input via a remote control. Thus, as typical use cases, conventional hologram devices can help provide an interesting focal point in design or décor of an office space, home, or business front. To illustrate, conventional hologram devices can be utilized to display realistic Halloween “ghosts” on a front porch or a depiction of “Santa” by a Christmas tree. Accordingly, there is a constant need in the art for hologram devices that can intelligently display graphical content. In addition, there is a need for structural elements that allow hologram devices to be utilized in ways that have yet to be accomplished or foreseen, especially with vehicles.

The subject matter claimed herein is not limited to examples that solve any disadvantages or that operate only in environments such as those described above. Rather, this background is only provided to illustrate one example technology area where some examples described herein may be practiced.

### SUMMARY

An aspect of the present disclosure relates to a system that includes: a hologram device securable adjacent to a window of a vehicle, a global positioning system (GPS) sensor, and a controller communicatively coupled to the hologram device. In some examples, the controller includes a processor and a memory device storing computer-executable instructions that, when executed by the processor, cause the processor to: identify geolocation data from the GPS sensor, determine graphical content to display via the hologram device based on the geolocation data, and display the graphical content via the hologram device.

In some examples, the system further includes a client device communicatively coupled to the controller, wherein the GPS sensor is positioned within the client device. The system can further include an image sensor communicatively coupled to the controller. In certain implementations, the image sensor is a camera carried by the controller. In other implementations, the image sensor is a vehicle camera carried by the vehicle.

In one or more examples, the graphical content includes a first display priority. The system can further include computer-executable instructions for determining targeted graphical content to display based on an image from the image sensor, the targeted graphical content comprising a second display priority that overrides the first display priority. In some examples, the targeted graphical content is based on alpha-numeric values of a license plate captured in the image. In certain examples, the graphical content includes an image or a video. The system can further include computer-executable instructions for generating a database of images and image data corresponding to the images.

Another aspect of the present disclosure relates to an apparatus that includes: a hologram device, a vehicle mount attachable to the hologram device, and a power supply in electrical communication with the hologram device. In some examples, the vehicle mount includes a suction cup configured to engage a vehicle window. In certain examples, the suction cup is a first suction cup positionable on a first lateral side of the hologram device, and the vehicle mount further includes: a second suction cup positionable on a second lateral side of the hologram device opposite the first lateral side; and a support bar extending between the first suction cup and the second suction cup and connected to the hologram device. In specific examples, the vehicle mount includes a stand, where the stand is mountable to a vehicle support surface. In another example, the vehicle mount includes a vehicle frame mount to suspend the hologram device from a vehicle frame adjacent to a vehicle window.

In one or more examples of the apparatus, the power supply can include a vehicle power supply. In some examples, the apparatus further includes a controller that includes a processor and a memory, the controller being communicatively coupled to the hologram device. In at least one example, the controller includes: a window mount to attach the controller to a vehicle window; and a camera to capture images through the vehicle window.

Yet another aspect of the present disclosure includes a method. The method can include: identifying a display trigger based on sensor data from a sensor; retrieving graphical content to display according to the display trigger; and presenting the graphical content for display via a hologram device, the hologram device being mountable to a window of a vehicle. In some examples, the sensor includes at least one of a global positioning system (GPS) sensor, an image sensor, or a motion sensor. In one or more examples, the sensor data includes at least one of geolocation data, image data, or vehicle motion data. In at least one example, identifying the display trigger includes at least one of: identifying, from the geolocation data, a current location corresponds to a certain geocoded area; identifying, from the image data, a target audience is within a field of view of the image sensor; or identifying, from the vehicle motion data, that the vehicle is either stopped or in transit.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a diagram of an example computing environment in which a vehicular hologram apparatus can operate in accordance with one or more examples;

FIG. 2 illustrates a schematic diagram of an example vehicular hologram apparatus in accordance with one or more examples;

FIG. 3 illustrates a front view of an example vehicle mount of a vehicular hologram apparatus in accordance with one or more examples;

FIG. 4 illustrates a front view of another example vehicle mount of a vehicular hologram apparatus in accordance with one or more examples;

FIG. 5 illustrates a front view of yet another example vehicle mount of a vehicular hologram apparatus in accordance with one or more examples;

FIGS. 6A-6C illustrate a sequence diagram for displaying at least one of graphical content or targeted graphical content via a vehicular hologram apparatus in accordance with one or more examples;

FIG. 7 illustrates an example of graphical content generated by a vehicular hologram apparatus in accordance with one or more examples;

FIG. 8 illustrates a flowchart of a series of acts for displaying graphical content via a vehicular hologram apparatus in accordance with one or more examples; and

FIG. 9 illustrates a block diagram of an example computing device implementing one or more examples of the present disclosure.

### DETAILED DESCRIPTION

Reference will now be made in detail to representative examples illustrated in the accompanying drawings. It should be understood that the following descriptions are not intended to limit the examples to one preferred example. To the contrary, it is intended to cover alternatives, modifications, and equivalents as can be included within the spirit and scope of the described examples as defined by the appended claims.

The following disclosure relates to a vehicular hologram apparatus that includes structure to provide compatibility with vehicles. For example, a vehicular hologram apparatus can include one or more suction cups that are mountable to a vehicle window. In such an example, a support bar can extend through a pair of suction cups and mount a hologram device adjacent to the vehicle window and between the pair of suction cups. In another example, a vehicular hologram apparatus includes a stand. The stand can be mounted to a vehicle support surface (e.g., a trunk shell, a dashboard, a vehicle body portion, a door portion, a flat mounting surface, etc.) and thereby support or uphold a hologram device in close proximity to a vehicle window. In yet another example, a vehicular hologram apparatus includes a vehicle frame mount. The vehicle frame mount can similarly include a support bar. However, instead of connecting to suction cups, end portions of the vehicle frame mount can attach to a vehicle frame positioned adjacent to the vehicle window. In this way, a hologram device can be suspended from the vehicle frame and in close proximity to the vehicle window. In these or other examples, the vehicular hologram apparatus can be removably attachable (e.g., for quick detachment and reattachment) as may be desired.

Another aspect of the present disclosure includes a vehicular hologram apparatus that can intelligently display graphical content based on geolocation. For example, the vehicular hologram apparatus can utilize geolocation data such as global positioning system (GPS) data to identify where the vehicular hologram apparatus is located. In some cases, the vehicular hologram apparatus can utilize the geolocation data to identify that the vehicular hologram apparatus is located at a particular geolocational zone, geocoded area, city, borough, or point of interest (e.g., tourist attraction, amusement park, festival, sports arena, etc.). In some examples, the vehicular hologram apparatus can utilize the geolocation data to identify that the vehicular hologram apparatus is located on a certain street, highway, interstate (or at a corresponding section, segment, milepost, etc.). Further, in some examples, the vehicular hologram apparatus can utilize the geolocation data to identify a direction of travel for the vehicular hologram apparatus. Additionally, in some examples, the vehicular hologram apparatus can determine other types of information based on the geolocation data (e.g., traffic conditions, weather conditions, nearby attractions or businesses, upcoming events, etc.). In these or other examples, the vehicular hologram apparatus can intelligently display graphical content and dynamically alter graphical content as the vehicular hologram apparatus changes location.

Yet another aspect of the present disclosure includes a vehicular hologram apparatus that can intelligently display graphical content based on vehicle motion. For example, the vehicular hologram apparatus can leverage various types of motion sensors (e.g., accelerometers, inertial measurement units, etc.) to identify whether the vehicular hologram apparatus is stopped or in transit according to movement of the vehicle mounting the vehicular hologram apparatus. In certain implementations, the vehicular hologram apparatus can display a static image while the vehicular hologram apparatus detects movement of the vehicle (e.g., when the vehicle is in-transit). Further, in some implementations, the vehicular hologram apparatus can display a video, animation, or a rolling sequence of images while the vehicular hologram apparatus detects no movement of the vehicle (e.g., when the vehicle is parked, idling, or otherwise stopped such as at a traffic light, stop sign, or traffic jam).

Still, another aspect of the present disclosure includes a vehicular hologram apparatus that can intelligently display graphical content to specific target audiences by utilizing an image sensor. In some examples, the image sensor is incorporated in the vehicular hologram apparatus. For instance, the image sensor can be located on or within a controller housing of the vehicular hologram apparatus (e.g., where the image sensor is oriented outward through a vehicle window to detect other vehicles and capture images of license plates). In other examples, the vehicular hologram apparatus leverages a vehicle camera (e.g., a fish-eye camera) to detect other vehicles and capture images of license plates. The vehicular hologram apparatus can, in turn, query the captured data against a database of targeted graphical content intended for specific target audiences. Additionally or alternatively, the vehicular hologram apparatus can leverage the captured image data (e.g., alpha-numeric values of a license plate) to mine identifying data and determine a profile match with one or more target audiences. If matched with a target audience, the vehicular hologram apparatus can then display targeted graphical content.

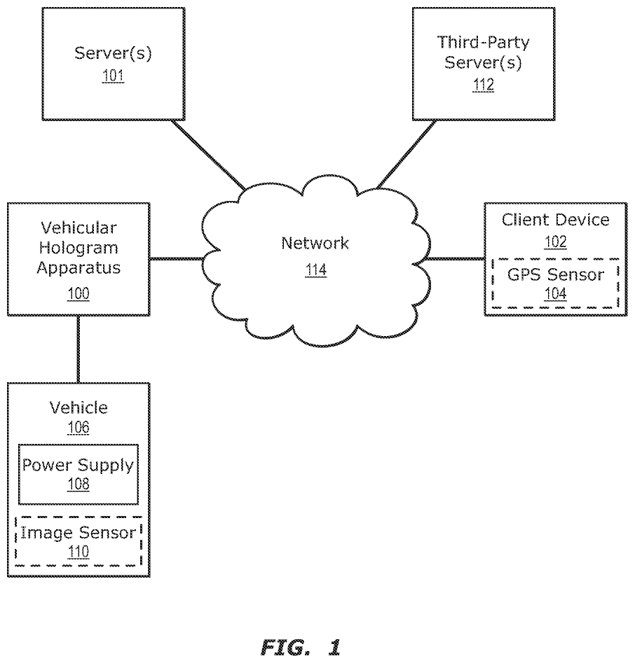

These and other examples are discussed below with reference to FIGS. 1-9. However, a person of ordinary skill in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a diagram of an example computing environment (hereafter “environment”) in which a vehicular hologram apparatus 100 can operate in accordance with one or more examples of the present disclosure. As shown, the environment can include the vehicular hologram apparatus 100, server(s) 101, a client device 102, a vehicle 106, third-party server(s) 112, and a network 114. Each is discussed in turn below.

The vehicular hologram apparatus 100 can be implemented to display graphical content in a holographic manner (e.g., as if the graphical content were three-dimensional or floating in the air). As used herein, the term “graphical content” refers to digital content displayed via one or more lighting elements (e.g., a light emitting diode (LED), LED bar, RGB (red, green, blue) display strip, etc.). Graphical content can, for example, include text, numbers, pictorial images, portraits, sequences of images, videos, animations, product images, company logos or trademarks, advertisements, notifications, safety information, sponsored announcements, etc. In particular implementations, graphical content can include information utilized by ride sharing platforms (e.g., LYFT and UBER). For instance, graphical content can include ride information, ride type, driver information, rider information, destination information, ride status information, pickup codes, visual indicators, etc.

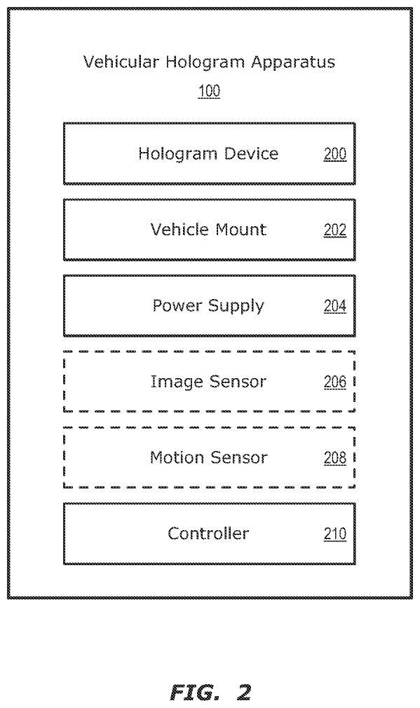

In some examples, graphical content include targeted graphical content. The term “targeted graphical content” refers to a specific type of graphical content that is preselected for a target audience (e.g., persons matching profile criteria based on factors such as demographic information, political affiliation information, social media information, application data, shopping history, browsing history, cookie data, etc.). Targeted graphical content can also refer to sponsored content (e.g., for a predetermined display duration or for a predetermined quantity of detected vehicles). Specific elements of the vehicular hologram apparatus 100 will be discussed further below in relation to FIGS. 2-5.

The environment shown in FIG. 1 can additionally include server(s) 101. The server(s) 101 can learn, generate, store, receive, and transmit electronic data, such as computer-executable instructions for displaying graphical content. Additionally or alternatively, the server(s) 101 can include a database of images, image data (e.g., location of image, timestamp, etc.), and/or graphical content (including targeted graphical content). For example, the server(s) 101 can receive targeted graphical content from third-party server(s) 112. In these or other examples, the server(s) 101 can communicate with at least one of the vehicular hologram apparatus 100 or the client device 102 to transmit and/or receive data via the network 114. In some aspects, the server(s) 101 include a content server and/or a data collection server. The server(s) 101 can also include an application server, a communication server, a web-hosting server, a social networking server, a digital content management server, or a transportation matching server (e.g., a LYFT server or an UBER server).

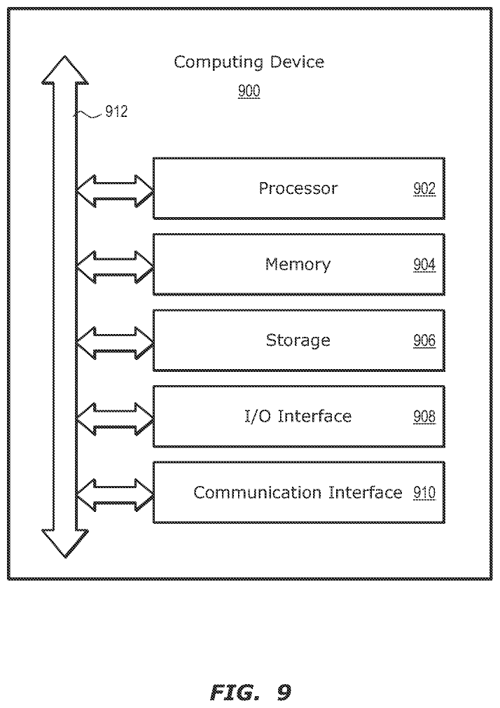

In addition, the environment shown in FIG. 1 can include the client device 102. The client device 102 can include one of a variety of computing devices, including a smartphone, tablet, smart television, desktop computer, laptop computer, virtual reality device, augmented reality device, or other computing device as described in relation to FIG. 9. In these or other examples, the client device 102 can communicate with the server(s) 101 and the vehicular hologram apparatus 100 via the network 114. For example, the client device 102 can receive user input and provide information pertaining to the user input (e.g., that relates to graphical content and/or settings for the vehicular hologram apparatus) to the server(s) 101. In another example, the client device 102 can generate geolocation data via a global positioning system (GPS) sensor 104. The GPS sensor 104 can generate geolocation data (e.g., GPS data, geocoded data, geohash data, city street data, etc.) that indicates a relative location of the client device 102. The client device 102 can, in turn, transmit the geolocation data to the vehicular hologram apparatus 100 for various processes (as will be explained more below). Although FIG. 1 illustrates a single client device, multiple client devices can also be implemented in the environment.

Although not expressly shown, the client device 102 can include a corresponding client application. The client application can include a web application, a native application installed on the client device 102 (e.g., a mobile application, a desktop application, etc.), or a cloud-based application where at least part of the functionality is performed by the server(s) 101. The client application can present or display information to a user of the client device 102, including geolocation data or data related to the vehicular hologram apparatus 100 (or other component of the environment in FIG. 1). A user can interact with the client application via the client device 102 to provide user input to, for example, remotely access the vehicular hologram apparatus 100.

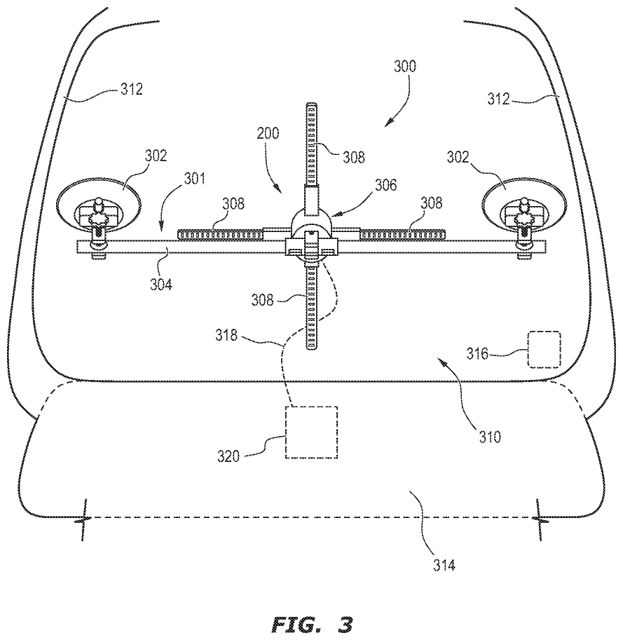

The environment of FIG. 1 can further include the vehicle 106. The vehicle 106 can include many different types of vehicles, including but not limited to automobiles, trucks, industrial equipment (e.g., cranes, fork-lifts, loaders, bull dozers, graders, etc.), motorcycles, scooters, bikes, etc. In specific implementations, the vehicle 106 includes a vehicle window or other portion to which the vehicular hologram apparatus 100 can be mounted (as will be discussed more below in relation to FIGS. 3-5).

In particular implementations, the vehicle 106 includes a power supply 108. As used herein, the terms “power supply” or “vehicle power supply” refer to one or more components that can provide power (e.g., to the vehicle 106 itself and/or to other components of the present disclosure). In at least on example, a power supply can provide power to one or more components of the vehicular hologram apparatus 100 (e.g., for operation and/or charging and recharging of certain components). For example, a power supply can include fuel cells, battery cells, generators, alternators, solar power converters, motion-based converters (e.g., that convert vibrations or oscillations into power), etc. In particular implementations, a power supply can convert alternating current to direct current (or vice-versa) for charging or recharging components of the vehicular hologram apparatus 100. Some particular examples of a power supply can include a switched mode power supply, an uninterruptible power supply, an alternating current power supply, a direct current power supply, a regulated power supply, a programmable power supply, a computer power supply, and a linear power supply.

In specific examples, the vehicle 106 can include an image sensor 110. The image sensor 110 can include an onboard vehicle camera. For example, the image sensor 110 can include a rear-facing camera typically employed by the vehicle 106 when in a reverse gear. Thus, in some examples, the image sensor 110 can be overridden by the vehicle 106 to capture image data specifically when the vehicle 106 is in reverse. In specific implementations, the image sensor 110 includes a fish-eye lens (e.g., for increased field of view). The image sensor 110 can also include vehicle image sensors that are located in other vehicle locations (e.g., side-facing image sensors, oblique-facing image sensors, and forward-facing image sensors). As will be discussed more below, the image sensor 110 (or an image sensor of the vehicular hologram apparatus 100) can capture images of detected vehicles for determining targeted graphical content to display via the vehicular hologram apparatus 100.

The third-party server(s) 112 can include a variety of different servers, like the server(s) 101. In some examples, the third-party server(s) 112 can include a content server and/or a data collection server. The server(s) 101 can also include an application server, a communication server, a web-hosting server, a social networking server, a digital content management server, or a transportation matching server (e.g., a LYFT server or an UBER server). In particular implementations, the third-party server(s) 112 include a server (e.g., a company server, business database, or advertisement repository) that provides targeted graphical content to the server(s) 101 via the network 114.

The network 114 can be any suitable network over which computing devices communicate. Indeed, any of the components shown in FIG. 1 can communicate with each other via the network 114. In these or other examples, the network 114 can include a wireless local area network, wireless area network, wireless personal area network, wide area network, etc. Some particular examples of wireless networks include a Wi-Fi based network, mesh network, BLUETOOTH® network, near-field communication network, low-energy communication network, Zigbee network, Z-wave network, and 6LoWPAN network. Other forms of the network 114 can include wired connections, such as a USB network, UART network, USART network, I2C network, SPI network, QSPI network, etc. Additional or alternative examples of the network 114 are discussed below in relation to a computing device in FIG. 9.

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIG. 1.

FIG. 2 illustrates a schematic diagram of the vehicular hologram apparatus 100 in accordance with one or more examples of the present disclosure. As shown, the vehicular hologram apparatus 100 can include a hologram device 200, a vehicle mount 202, a power supply 204, and a controller 210. Optionally, the vehicular hologram apparatus 100 can also include an image sensor 206 and/or a motion sensor 208. The foregoing elements are each discussed in turn.

The hologram device 200 can include the various elements to present graphical content. In particular implementations, the hologram device 200 includes a fan and associated fan blade(s). Lighting elements such as LED bars can be positioned on the one or more fan blades. The one or more fan blades can be rotated at high speeds (e.g., in excess of about 300 revolutions per minute), thereby rendering the one or more fan blades practically invisible to the unaided human eye and producing a transparent background. In combination with the lighting elements on the one or more fan blades, the hologram device 200 can produce an illusion of a holographic 3D object.

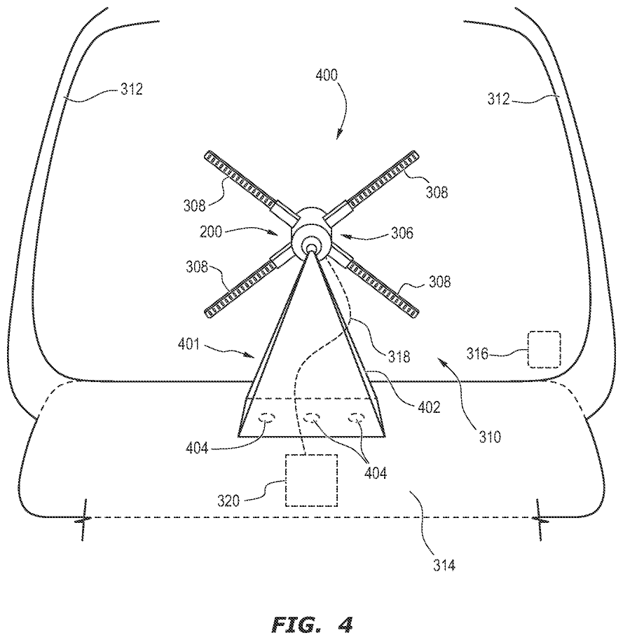

The vehicular hologram apparatus 100 can further include a vehicle mount 202. As used herein, the term “vehicle mount” refers to one or more attachment components to attach (e.g., removably attach) the vehicular hologram apparatus 100 to a vehicle. In one example, the vehicle mount 202 includes suction cups configured to engage a vehicle window (e.g., as shown and described in relation to FIG. 3). In another example, the vehicle mount 202 includes a stand configured to engage a support surface (e.g., a trunk shell, a dashboard, a vehicle body portion, a door portion, a flat mounting surface, etc.) and thereby support or uphold the hologram device 200 in close proximity to a vehicle window. Aspects of the vehicle mount 202 having a “stand” configuration are shown and described in relation to FIG. 4. In yet another example, the vehicle mount 202 includes a vehicle frame mount with end portions that can attach to a vehicle frame (e.g., a periphery of the vehicle body positioned adjacent to the vehicle window and which forms the opening for a vehicle window). In this way, the hologram device 200 can be suspended from the vehicle frame and in close proximity to the vehicle window.

The vehicular hologram apparatus 100 can also include a power supply 204. The power supply 204 is separate from the vehicle power supply (i.e., the power supply 108 of the vehicle 106 in FIG. 1). In particular, the power supply 204 can be in electrical communication (e.g., electrically wired to or electrically connected) with the hologram device 200. Specifically, the power supply 204 can provide power to one or more components of the vehicular hologram apparatus 100 when the vehicle is turned off (so as not to drain the vehicle power supply). For example, the power supply 204 can, when the vehicle is turned off, provide power to a cooling fan of a motor for the hologram device 200. In another example, the power supply 204 can, when the vehicle is turned off, provide power to the controller 210 so that the controller 210 (if connected to a wireless network) can upload captured images and image data to the server(s) 101. In these or other examples, the power supply 204 can include a rechargeable battery that is recharged via the vehicle power supply when the vehicle is turned on. In alternative examples, the power supply 204 includes a removable/replaceable battery, or a rechargeable battery that can be disconnected and charged via a charging dock or electrical outlet.

The vehicular hologram apparatus 100 can optionally include an image sensor 206. Indeed, the image sensor 206 may not be necessary when implemented with vehicles that have a vehicular camera. Nonetheless, the image sensor 206 can still be implemented as a secondary camera and/or in the event the vehicular camera is not readily compatible with the vehicular hologram apparatus 100. In these or other examples, the image sensor 206 can, like the vehicular camera, capture images of detected vehicles (and specifically, vehicle license plates).

The image sensor 206 can include various image resolutions. In specific examples, the image resolution is constant (e.g., 1080p resolution). In other examples, the image resolution can be varied—depending on available storage and/or depending on a perceived distance (e.g., pixel size) of an identified license plate. In some examples, and for purposes of image recognition processes, at least a minimum image resolution (e.g., 240p resolution) of an identified license plate can be implemented.

The vehicular hologram apparatus 100 can also include a motion sensor 208. The motion sensor 208 can identify whether the vehicular hologram apparatus 100 is stopped or in motion (i.e., in-transit according to motion of the vehicle mounting the vehicular hologram apparatus 100). In some examples, the motion sensor 208 includes an accelerometer, inertial measurement unit, passive infrared sensor, microwave sensor, tomographic sensor, vibration sensor, acoustic sensor, ultrasonic transducer, ultrasonic motion sensor, area reflective sensor, photoelectric sensor, or a combination thereof. In these or other examples, the motion sensor 208 can generate motion data continuously (e.g., in real time or near real time) or at predetermined time intervals (e.g., about every 3 seconds, about every 5 seconds, about every 10 seconds, etc.).

The controller 210 can include a processor and a memory device. The processor can include one or more of a system on chip, integrated circuit, driver, microcontroller, application processor, crossover processor, etc. The memory device can include one or more memory devices that can include individual nonvolatile memory, processor-embedded nonvolatile memory, random access memory, memory integrated circuits, DRAM chips, stacked memory modules, storage devices, memory partitions, etc. The memory device can store computer-executable instructions that, when executed by the processor, cause the processor to perform various operations.

In some examples, the controller 210 performs an operation that includes identifying geolocation data from a GPS sensor (e.g., a GPS sensor located at the client device 102 discussed above or a GPS sensor carried by the vehicular hologram apparatus 100). In certain examples, the controller 210 performs another operation that includes determining graphical content to display via the hologram device 200 based on the geolocation data. Further, in some examples, the controller 210 performs another operation that includes displaying the graphical content via the hologram device 200.

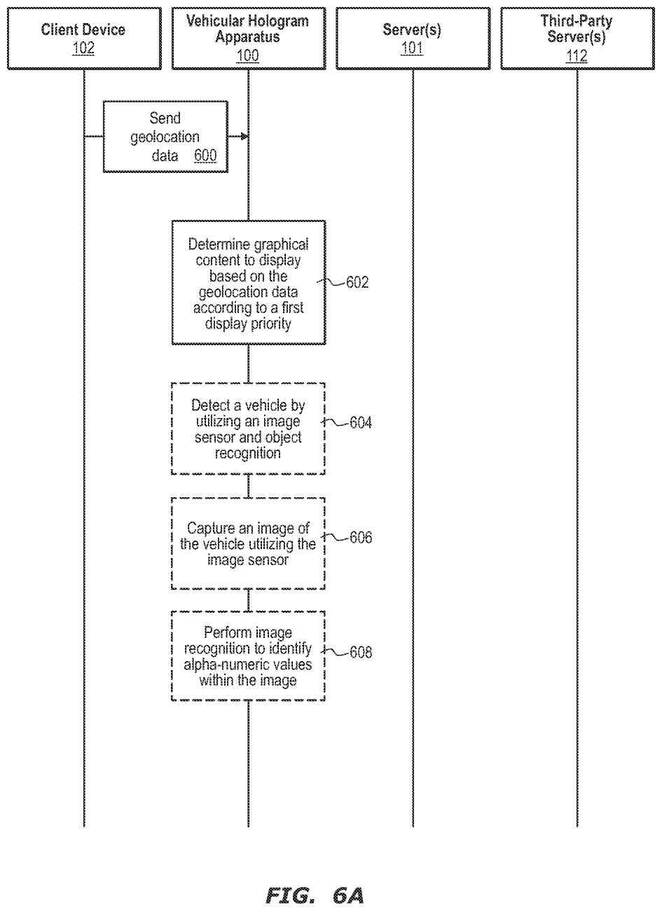

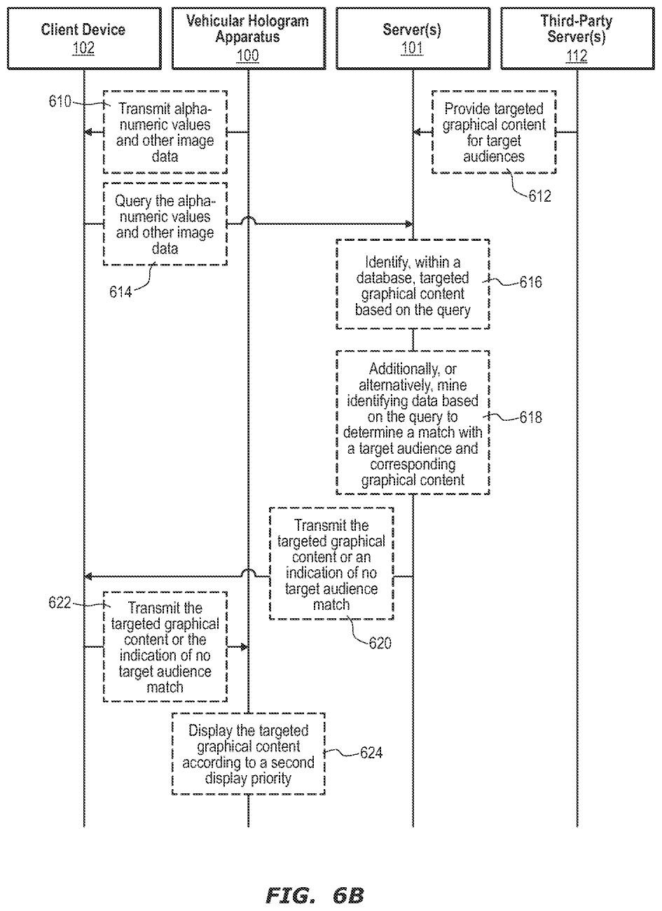

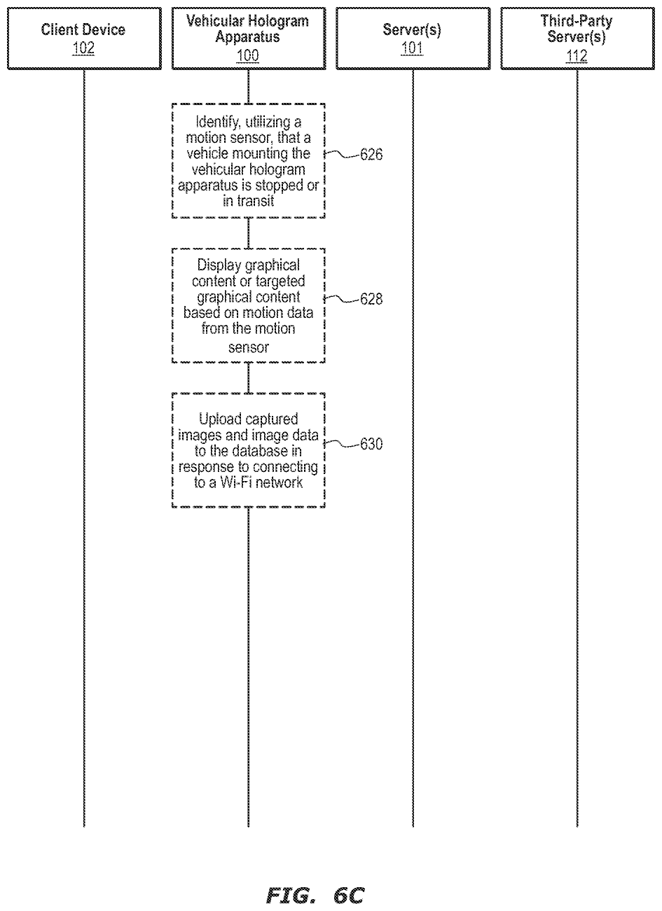

Additionally or alternatively, the controller 210 can perform other operations in response to the processor executing computer-executable instructions stored on the memory device. For example, the controller 210 can determine targeted graphical content to display based on an image captured by the image sensor 206. In certain examples, determining the targeted graphical content to display can include performing object detection (e.g., by utilizing machine-learning models or object detection algorithms) such that a vehicle is identifiable within a field of view of the image sensor 206. From a captured image of a vehicle, the controller 210 can perform image recognition processes (e.g., by utilizing one or more additional machine-learning models and/or image recognition algorithms). Via image recognition, the controller 210 can specifically identify alpha-numeric values or symbols on a license plate that are indicative of an owner of the vehicle based on publicly available information tied to the license plate values. In this manner, the controller 210 can provide identifying data to the server(s) 101 (e.g., via the client device 102) in order to retrieve targeted graphical content. Still further, the controller 210 can generate a database of image and image data corresponding to the images. The foregoing operations performed by the controller 210 are discussed in more detail below in relation to FIGS. 6A-6C.

The vehicular hologram apparatus 100 can also include other features, components, and/or parts. For example, the vehicular hologram apparatus 100 can include a fan cage or protective guard (e.g., where the fan cage can still allow a user to view the outside environment through the fan cage). As another example, the vehicular hologram apparatus 100 can include a heat sink to help dissipate heat generated by the vehicular hologram apparatus 100. In yet another example, the vehicular hologram apparatus 100 can include one or more noise-reducing elements, sound dampeners, etc.

Any of the features, components, and/or parts, including the arrangements and configurations thereof shown in FIG. 2 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIG. 2.

As mentioned above, there are various ways to mount the hologram device 200 to a vehicle. The following figures (i.e., FIGS. 3-5) describe some example ways in which mounting the hologram device 200 to a vehicle can be accomplished. It will be appreciated by those of ordinary skill in the art that the example structure illustrated in these figures is a first-of-its-kind structure that allows an unprecedented combining of a hologram device with vehicular components. It will also be appreciated by those of ordinary skill in the art that the structure shown or described in relation to these figures can be modified in various ways that fall within the scope and spirit of the present disclosure (e.g., to accommodate different state laws relating to vehicle window visibility or vehicle window obstructions).

FIG. 3 illustrates a front view of example vehicle mount 301 of a vehicular hologram apparatus 300 in accordance with one or more examples of the present disclosure. In this view, the vehicular hologram apparatus 300 is viewed from the perspective of within an interior cabin of a vehicle and looking toward a vehicle window (e.g., a rear window). The vehicular hologram apparatus 300 can be the same as or similar to the vehicular hologram apparatus 100 discussed above. The vehicular hologram apparatus 300 can be mounted to a vehicle via the vehicle mount 301, as will now be discussed.

The vehicle mount 301 can include one or more suction cups 302 to mount the hologram device 200—namely a fan 306 and corresponding blades 308—in close proximity to (e.g., within about 6 inches, within about 3 inches, or within about 1 inch of) a vehicle window 310. The one or more suction cups 302 can include a pliant material (e.g., rubber or silicone) that can be deformed or depressed to induce a vacuum seal against a surface of the vehicle window 310. In some examples, the one or more suction cups 302 include a lock or actuator that can help evacuate or introduce air for controlling the presence of a vacuum between the one or more suction cups 302 and the vehicle window 310. Accordingly, the one or more suction cups 302 can be easily mounted and dismounted from the vehicle window 310.

In a specific implementation, the vehicle mount 301 includes a pair of suction cups 302 attachable to the vehicle window 310. For example, the vehicle mount 301 can include a first suction cup positioned on a first lateral side of the hologram device 200, and a second section cup positioned on a second lateral side of the hologram device 200 opposite the first lateral side. In some examples, dual suction cups 302 can help provide increased stability for the hologram device 200 and a robust connection to the vehicle window 310.

FIG. 3 further shows the vehicle mount 301 can include a support bar 304. The support bar 304 can include an elongated member, such as a rod, beam, pole, plank, or post. In some examples, the support bar 304 can extend between the pair of suction cups 302—with a first end of the support bar 304 connecting to a first suction cup 302 and an opposing second end of the support bar 304 connecting to a second suction cup 302. In certain examples, the support bar 304 is removably attached to each of the suction cups 302. For instance, the support bar 304 can be inserted and locked (or fastened) into place within the suction cups 302. Further, in some examples, the support bar 304 can be detached from the pair of suction cups 302. In these or other examples, the support bar 304 can be adjustably connected to the pair of suction cups 302. For instance, a length of the support bar 304 can be increased or decreased (e.g., telescopically adjusted) to accommodate different sizes of the vehicle window 310.

In one or more examples, the support bar 304 can support or uphold the hologram device 200. For example, the hologram device 200 can be mounted to a central portion of the support bar 304 between end portions connected to the suction cups 302. Additionally or alternatively, the hologram device 200 can be laterally shifted left or right of center to a desired location between the suction cups 302. In particular examples, the hologram device 200 can be rotatably mounted to the support bar 304. For instance, a mounting angle of the hologram device 200 can be adjusted (e.g., by rotating a mounting fixture or clamp connecting the fan 306 to the support bar 304). With an adjustable mounting angle, the fan 306 and the blades 308 can be oriented relative to (e.g., parallel to) the vehicle window 310. Indeed, an angle between the vehicle window 310 and a support surface 314 positioned below the vehicle window 310 can vary from vehicle to vehicle, and thus the hologram device 200 can be mounted at a variety of compatible angles and orientations for universal operability across different vehicles.

Additionally shown in FIG. 3, vehicular hologram apparatus 300 can include a controller 316. The controller 316 can be communicatively coupled—via a wired or wireless network connection—to the hologram device 200 and a client device (e.g., the client device 102). In some examples, the controller 316 is mounted to the vehicle window 310. The controller 316 can be mounted in a variety of locations on the vehicle window 310 and is not limited to the illustrated position. Indeed, the controller 316 can be positioned in a more central window location or other position (e.g., where the rear windshield wipers can clear an obstructed window view for an image sensor carried by the controller 316). In other examples, the controller 316 can mounted at other locations besides the vehicle window 310. For example, the controller 316 can be hidden from view (e.g., positioned within the vehicle frame 312 or below the vehicle support surface 314). Such examples may be applicable in implementations where the controller 316 does not carry an image sensor and need not have a field of view through the vehicle window 310.

In one or more examples, the controller 316 can include a window mount positioned between the controller 316 and the vehicle window 310. The window mount can include a suction cup (similar to the suction cups 302). Additionally or alternatively, the window mount can include an adhesive or fastener to secure the controller 316 to the vehicle window 310.

Further, in some examples, the controller 316 can include an image sensor (or camera) to capture images through the vehicle window 310. Thus, the image sensor, can be oriented to face outward through the vehicle window 310 so as to capture images of vehicles (and associated license plates). This process is described more below in relation to FIGS. 6A-6C with respect to identifying targeted graphical content to display at the hologram device 200.

In some examples, a cable 318 can provide power to the fan 306 from a vehicle power supply 320 (e.g., a vehicle battery). The cable 318 can be routed through one or more components and/or exposed.

Any of the features, components, and/or parts, including the arrangements and configurations thereof shown in FIG. 3 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIG. 3.

FIG. 4 illustrates a front view of another example vehicle mount 401 of a vehicular hologram apparatus 400 in accordance with one or more examples of the present disclosure. Like in FIG. 3, the vehicular hologram apparatus 400 is viewed from the perspective of within an interior cabin of a vehicle and looking toward a vehicle window (e.g., a rear window). The vehicular hologram apparatus 400 can be the same as or similar to the vehicular hologram apparatus 100 discussed above. Additionally, the vehicular hologram apparatus 400 can include certain elements that are the same as or similar to the vehicular hologram apparatus 300 (as denoted by the common reference numerals). The vehicular hologram apparatus 400 can be mounted to a vehicle via the vehicle mount 401, as will now be discussed.

As shown in FIG. 4, the vehicle mount 401 can include a stand 402. The stand 402 can include a mounting fixture that couples the hologram device 200 and the vehicle support surface 314 positioned below the vehicle window 310. The stand 402 can also be adjusted. For instance, the stand 402 can be height-adjustable such that the hologram device 200 is raised or lowered to a desired position relative to the vehicle window 310. Likewise, the stand 402 can be angularly adjustable. For instance, the stand 402 can include a pivot connection, hinge, ball-and-socket joint, or other movable connection such that the fan 306 and the blades 308 can be angularly oriented relative to the vehicle window 310 (e.g., to match an angle at which the vehicle window 310 is positioned relative to the vehicle support surface 314).

In some examples, the stand 402 is attached to the vehicle support surface 314 via fasteners 404 (e.g., bolts, screws, interlocking features, mating features, button snaps, VELCRO® strips, etc.). In these or other examples, the stand 402 can be removably attached to the vehicle support surface 314 (e.g., allowing for convenient, ergonomic detachment and reattachment).

Any of the features, components, and/or parts, including the arrangements and configurations thereof shown in FIG. 4 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIG. 4.

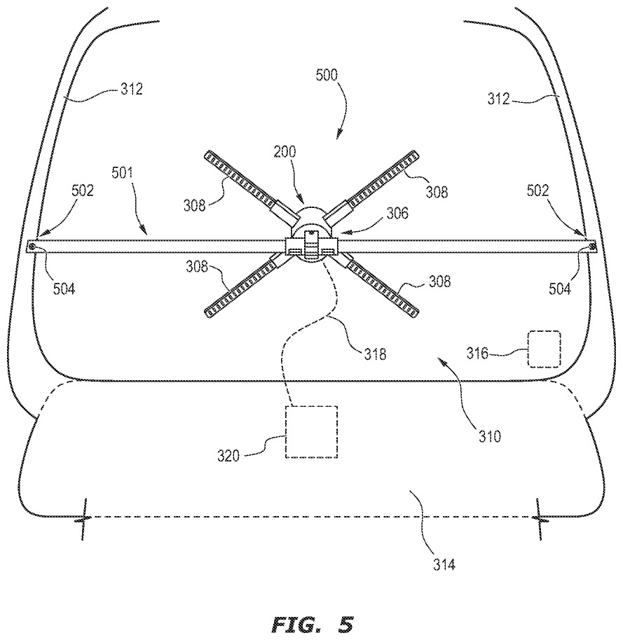

FIG. 5 illustrates a front view of yet another example vehicle mount 501 of a vehicular hologram apparatus 500 in accordance with one or more examples of the present disclosure. Like in FIGS. 3 and 4, the vehicular hologram apparatus 500 is viewed from the perspective of within an interior cabin of a vehicle and looking toward a vehicle window (e.g., a rear window). The vehicular hologram apparatus 500 can be the same as or similar to the vehicular hologram apparatus 100 discussed above. Additionally, the vehicular hologram apparatus 500 can include certain elements that are the same as or similar to the vehicular hologram apparatus 300 (as denoted by the common reference numerals). The vehicular hologram apparatus 500 can be mounted to a vehicle via the vehicle mount 501, as will now be discussed.

The vehicle mount 501 can, like the vehicle mount 301 of FIG. 3, include the support bar 304. However, instead of end portions of the support bar 304 connecting to suction cups, the portions of the support bar 304 form part of a vehicle frame mount 502. Specifically, end portions of the support bar 304 extend between and attach to opposing sides of the vehicle window 310 (i.e., at opposing sides of the vehicle frame 312 that define the opening for the vehicle window 310). The support bar 304 can adjust to different frame sizes and therefore accommodate different distances between opposing sides of the vehicle frame 312. Likewise, the hologram device 200 can be angularly adjusted (i.e., tilted) or laterally shifted (i.e., translated left or right) along the support bar 304 of the vehicle mount 501—similar to the vehicle mount 301.

In these and other examples, the support bar 304 can be attached (e.g., removably attached) to the vehicle frame 312 via fasteners 504. Examples of the fasteners 504 can include bolts, screws, pins, locking elements, button snaps, VELCRO® strips, interlocking features, etc. Additionally or alternatively, the support bar 304 can be inserted into a receiving aperture defined in the vehicle frame 312, where the support bar 304 can be locked in place, press-fit, bonded, fastened, or the like.

Although not shown, the support bar 304 can be modified for the vehicle frame mount 502. For example, the support bar 304 can be shaped to provide a desired clearance between the hologram device 200 and the vehicle window 310. For instance, in one implementation, the support bar 304 can be “U” shaped, and the hologram device 200 can be positioned within the concave bell portion of the support bar 304 to maintain clearance between the fan 306 (and corresponding blades 308) relative to the vehicle window 310.

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIG. 5.

As discussed above, a vehicular hologram apparatus of the present disclosure can display graphical content and/or targeted graphical content in a vehicle. To do so, the vehicular hologram apparatus performs various operations (e.g., acts and/or algorithms)—in relation to other components shown in FIG. 1—that will now be discussed. Furthermore, and as mentioned below, many of these operations can be dynamically performed in real time (e.g., as the vehicular hologram apparatus 100 is in transit with the vehicle 106 mounting the vehicular hologram apparatus 100). FIGS. 6A-6C illustrate a sequence diagram for displaying at least one of graphical content or targeted graphical content via a vehicular hologram apparatus in accordance with one or more examples of the present disclosure. While FIGS. 6A-6C illustrate acts according to one or more aspects, alternative aspects may omit, add to, reorder, and/or modify any of the acts shown in FIGS. 6A-6C.

At an act 600, the client device 102 can send geolocation data to the vehicular hologram apparatus 100. For example, the client device 102 can send GPS data from a GPS sensor onboard the client device 102. In these or other examples, the geolocation data can be used as indicative of a real time location of the vehicular hologram apparatus 100 (e.g., as the vehicle mounting the vehicular hologram apparatus 100 is in-transit).

At an act 602, the vehicular hologram apparatus 100 can determine graphical content to display based on the geolocation data according to a first display priority. In some examples, the vehicular hologram apparatus 100 can dynamically display certain graphical content that is location specific (e.g., one or more of a first set of images or videos at a first location, and one or more of a second set of images or videos at a second location that differs from the first location). For example, the vehicular hologram apparatus 100 may display graphic content relating to a first borough (e.g., points of interest, shopping centers, or businesses located in the first borough) while the geolocation data indicates the client device 102 (and therefore the vehicular hologram apparatus 100) is currently located in the first borough. Likewise, the vehicular hologram apparatus can display graphic content relating to a second borough (e.g., points of interest, shopping centers, or businesses located in the second borough) while the geolocation data indicates the client device 102 (and therefore the vehicular hologram apparatus 100) is currently located in the second borough.

The vehicular hologram apparatus 100 can display the graphic content based on geolocation data according to the first display priority. As used herein, the term “display priority” refers to a sequence, order, duration, or emphasis assigned to graphical content. Graphic content with a higher display priority can be displayed first, for longer durations, with more repetition, and/or with greater visual emphasis (e.g., with increased image resolution, brighter colors, larger image size, more attention-grabbing visual aids, etc.) compared to graphic content with a lower display priority.

At an act 604, the vehicular hologram apparatus 100 can detect a vehicle in real time by utilizing an image sensor and object recognition. For example, an image sensor carried by the controller 210 (or the vehicle 106) can include a field of view that encompasses vehicles (e.g., that pass by or drive behind the vehicle 106). The vehicular hologram apparatus 100 can utilize object detection machine-learning models or object detection algorithms to identify vehicles (or in particular implementations, vehicles with license plates or just the license plates themselves) within a field of view of the image sensor. For example, the vehicular hologram apparatus 100 can utilize convolutional neural networks (e.g., R-CNN, region-based CNN), Fast R-CNN, YOLO (You Only Look Once), RetinaNet, etc. to identify vehicles using the image sensor. Additionally or alternatively, the vehicular hologram apparatus 100 can utilize various object detection libraries (e.g., ImageAI, GluonCV, Detectron2, YOLOv3_TensorFlow, Darkflow, etc.) to identify other vehicles using the image sensor.

At an act 606, the vehicular hologram apparatus 100 can capture an image of the vehicle (or just the license plate) in real time utilizing the image sensor. Specifically, based on detecting a vehicle at the act 604, the vehicular hologram apparatus 100 can cause the image sensor to capture an image. In addition, the vehicular hologram apparatus 100 can store the captured image.

At an act 608, the vehicular hologram apparatus 100 can perform image recognition on the fly to identify alpha-numeric values within the image. The vehicular hologram apparatus 100 can perform image recognition in various ways. In some examples, the vehicular hologram apparatus 100 can utilize text extraction machine-learning models. In some examples, the text extraction machine-learning models can use region-based methods (e.g., that use a sliding detection window to detect text and that rely on various factors like color, edge, shape, contour, and geometry features). In some examples, the text extraction machine-learning models can use texture-based methods (e.g., that use various kinds of texture and associated properties to extract text from an image). In some examples, the text extraction machine-learning models can use hybrid methods (e.g., that first use region-based methods detect text regions and then texture-based methods to extract features from the detected text region). In certain examples, the text extraction machine-learning models can use edge-based methods (e.g., that use the edges of letters and digits to detect and extract alpha-numeric values). Still, other examples of text extraction machine-learning models use morphological based methods in which all text-related features are extracted from an image. Additionally or alternatively, text extraction algorithms and libraries can be utilized to identify alpha-numeric values within the image. In certain examples, the vehicular hologram apparatus 100 can utilize optical character recognition algorithms to identify alpha-numeric values within the image.

At an act 610, the vehicular hologram apparatus 100 can transmit alpha-numeric values and other image data to the client device 102. For example, the vehicular hologram apparatus 100 can transmit the captured image. In addition, the vehicular hologram apparatus 100 can transmit the alpha-numeric values identified from the captured image. Further, in some examples, the vehicular hologram apparatus 100 can transmit other image data, such as a timestamp at which the captured image was taken, a location at which the captured image was taken (based on the geolocation data from the client device 102), and various image metadata. Alternatively, at the act 610, the vehicular hologram apparatus 100 can transmit alpha-numeric values and other image data to the server(s) 101.

At an act 612, the third-party server(s) 112 can provide targeted graphical content for target audiences to the server(s) 101. In some examples, the third-party server(s) 112 can provide different sets of targeted graphical content that are specific to different target audiences (e.g., a first video for a first target audience and a second video for a second target audience different from the first target audience). As another example, the third-party server(s) 112 can provide targeted graphical content that is intended for display at the vehicular hologram apparatus 100 for a predetermined duration or for a predetermined quantity of vehicles detected by the vehicular hologram apparatus 100. In these or other examples, the server(s) 101 can generate a database that includes (i) the provided targeted graphical content from the third-party server(s) 112 and (ii) the target audience intended for the targeted graphical content.

At an act 614, the client device 102 can query the alpha-numeric values and other image data in real time. For example, the client device 102 can transmit a digital communication to the server(s) 101 that includes a query to match (or find a closest match) for the alpha-numeric values and/or other image data.

At an act 616, the server(s) 101 can identify, within a database (and on the fly), targeted graphical content based on the query. In particular, the server(s) 101 can search the database of target audiences to determine a best match to the queried data (i.e., the alpha-numeric values and other image data). Based on identifying a best match (e.g., within a threshold fit to criteria specified for the target audience), the server(s) 101 can identify the targeted graphical content that corresponds to the matched target audience.

It will be appreciated that the target audience provided by the third-party server(s) 112 may not include the alpha-numeric values (e.g., license plate numbers) extracted from the captured image at the vehicular hologram apparatus 100. Thus, at an act 618, the server(s) 101 can additionally, or alternatively, mine identifying data in real time based on the query from the act 614 to determine a match with a target audience and corresponding graphical content. For example, at the act 618, the server(s) 101 can utilize publicly available databases (e.g., from other third party servers 112) to scrape identifying data tied to the alpha-numeric values or other image data. With the newly mined data, the server(s) 101 can then identify the targeted graphical content that corresponds to the matched target audience.

At an act 620, the server(s) 101 can transmit the targeted graphical content or an indication of no target audience match to the client device 102. At an act 622, the client device 102 can transmit the targeted graphical content or the indication of no target audience match to the vehicular hologram apparatus 100.

At an act 624, the vehicular hologram apparatus 100 can display the targeted graphical content according to a second display priority. In particular examples, the second display priority for targeted graphical content is higher than the first priority for graphical content. Thus, in some examples, the targeted graphical content can, in real time, override the graphical content such that the vehicular hologram apparatus 100 stops displaying the graphical content (e.g., based on geolocation data) and starts displaying the targeted graphical content. In these or other examples, the vehicular hologram apparatus 100 can display the targeted graphical content ahead of the graphical content, for longer durations than the graphical content, with more repetition than the graphical content, and/or with greater visual emphasis than the graphical content (e.g., with increased image resolution, brighter colors, larger image size, more attention-grabbing visual aids, etc.).

At an act 626, the vehicular hologram apparatus 100 can identify, utilizing a motion sensor, that a vehicle (e.g., the vehicle 106) mounting the vehicular hologram apparatus is stopped or in transit. This dynamic determination can occur on the fly as the vehicle 106 moves (or stops moving). For example, an inertial measurement unit within the vehicular hologram apparatus 100 can generate motion data that indicates the vehicle 106 is stopped or in-transit.

At an act 628, the vehicular hologram apparatus 100 can display graphical content or targeted graphical content based on motion data from the motion sensor. For example, the vehicular hologram apparatus 100 can display a static image while the motion data indicates movement of the vehicle 106 (e.g., when the vehicle 106 is in-transit). Further, in some implementations, the vehicular hologram apparatus 100 can display a video, animation, or a rolling sequence of images while the motion data indicates no movement of the vehicle (e.g., when the vehicle is parked, idling, or otherwise stopped such as at a traffic light, stop sign, or traffic jam).

Additionally or alternatively, the vehicular hologram apparatus 100 can display graphical content or targeted graphical content based on time of day or weather conditions. For example, the vehicular hologram apparatus can display more videos at nighttime (or during cloudy weather) when there is improved visibility of the graphical content or targeted graphical content, and more static images during the daytime (or during prevailing sunny conditions) when there is decreased visibility of the graphical content or targeted graphical content.

At an act 630, the vehicular hologram apparatus 100 can upload captured images and image data to the database in response to connecting to a Wi-Fi network (or other network disclosed herein). For example, the vehicular hologram apparatus 100 can, with each upload, add to the database stored on the server(s) 101. In this way, as more vehicles are detected, and more target audiences are identified, the vehicular hologram apparatus 100 can display targeted graphical content with increased statistical confidence. For instance, the vehicular hologram apparatus 100 can begin to identify the same individuals on a daily commute or driving schedule that correspond to a previously identified target audience—and therefore display more of the same targeted graphical content (or related targeted graphical content) at particular times and locations.

As mentioned above, the acts shown and described in relation to FIGS. 6A-6C can be modified. For example, the vehicular hologram apparatus 100 need not display graphical content based on geolocation data. For instance, in some examples, the vehicular hologram apparatus 100 can display graphical content according to predetermined settings, a display program, or randomly. Likewise, the vehicular hologram apparatus 100 can display targeted graphical content in various different ways (e.g., according to parameters provided by the third-party servers 112, according to controller settings, etc.).

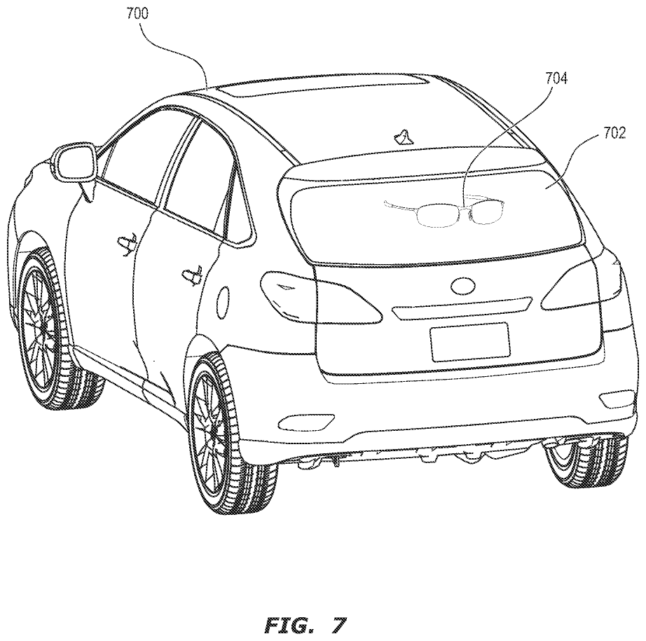

FIG. 7 illustrates an example of graphical content 704 generated by a vehicular hologram apparatus in accordance with one or more examples of the present disclosure. In this view, FIG. 7 portrays a rear view of a vehicle 700 having a window 702. Additionally shown, the graphical content 704 generated by a vehicular hologram apparatus of the present disclosure is visible through the window 702. Accordingly, people (e.g., drivers and/or pedestrians) that can see the window 702 can also see the graphical content 704. As discussed above, a vehicular hologram apparatus of the present disclosure can display many different types of graphical content and in response to different display triggers (e.g., based on geolocation, in response to vehicle movement, and/or based on identification of a target audience).

Further, those of ordinary skill in the art will appreciate that a vehicular hologram apparatus of the present disclosure is not limited to displaying graphical content at certain vehicle windows. Indeed, the graphical content 704 can additionally or alternatively be shown at a side window and/or a front window.

Any of the features, components, and/or parts, including the arrangements and configurations thereof shown in FIG. 7 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIG. 7.

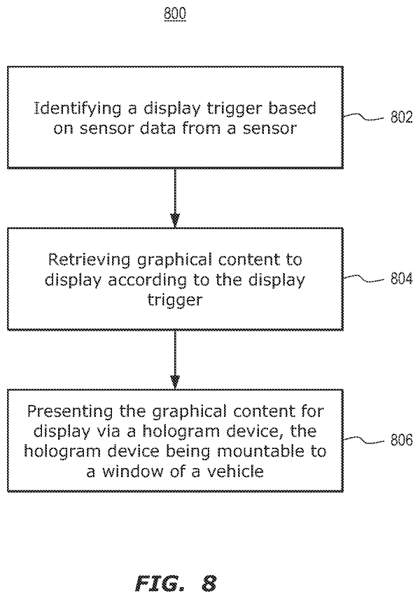

FIGS. 1-7, the corresponding text, and the examples provide several different systems, methods, techniques, components, and/or devices of a vehicular hologram apparatus in accordance with one or more aspects. In addition to the above description, one or more aspects can also be described in terms of flowcharts including acts for accomplishing a particular result. For example, FIG. 8 illustrates a flowchart of a series of acts 800 for displaying graphical content via a vehicular hologram apparatus in accordance with one or more aspects. The vehicular hologram apparatus may perform one or more acts of the series of acts 800 in addition to or alternatively to one or more acts described in conjunction with other figures, such as FIGS. 6A-6C. While FIG. 8 illustrates acts according to one aspect, alternative aspects may omit, add to, reorder, and/or modify any of the acts shown in FIG. 8. The acts of FIG. 8 can be performed as part of a method. Alternatively, a non-transitory computer-readable medium can include instructions that, when executed by one or more processors, cause a computing device to perform the acts of FIG. 8. In some aspects, a system can perform the acts of FIG. 8.

As shown, the series of acts 800 includes an act 802 of identifying a display trigger based on sensor data from a sensor. The sensor data can include at least one of geolocation data, image data, or vehicle motion data. Further, in some examples, the sensor can include at least one of a global positioning system (GPS) sensor, an image sensor, or a motion sensor.

In some examples, identifying the display trigger includes identifying, from the geolocation data, a current location corresponds to a certain geocoded area. In certain examples, identifying the display trigger includes identifying, from the image data, a target audience is within a field of view of the image sensor. Further, in some examples, identifying the display trigger includes identifying, from the vehicle motion data, that the vehicle is either stopped or in transit. Thus, a display trigger can include detecting a location, movement of a vehicle mounting the vehicular hologram apparatus, or a target audience.

The series of acts 800 can further include an act 804 of retrieving graphical content to display according to the display trigger. As discussed above, retrieving graphical content can include identifying graphical content that is specific to a location of the vehicular hologram apparatus. In some examples, retrieving graphical content can include identifying graphical content that is tailored to the movement (or non-movement) of a vehicle mounting the vehicular hologram apparatus. In certain examples, retrieving graphical content can include retrieving targeted graphical content that is specifically adapted to (or intended for) a target audience.

The series of acts 800 can also include an act 806 of presenting the graphical content for display via a hologram device, the hologram device being mountable to a window of a vehicle. As also discussed above, presenting the graphical content for display includes causing fan blades or other light-emitting component to rapidly spin and light up in a controlled fashion to form an image or other graphical content. The fan blades can be positioned adjacent to a vehicle window so as to prominently display the image for external viewing through the vehicle window.

It is understood that the outlined acts in the series of acts 800 are only provided as examples, and some of the acts may be optional, combined into fewer acts, or expanded into additional acts without detracting from the essence of the disclosed aspects.

Examples of the present disclosure may include or utilize a special purpose or general-purpose computer including computer hardware, such as, for example, one or more processors and system memory, as discussed in greater detail below. Aspects within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, aspects of the disclosure can include at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions include, for example, instructions and data which, when executed by a processor, cause a general-purpose computer, special purpose computer, or special purpose processing device to perform a certain function or group of functions. In some aspects, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Aspects of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 9 illustrates a block diagram of an example computing device 900 that can be configured to implement one or more examples of the present disclosure. One will appreciate that one or more computing devices, such as the computing device 900 may represent the computing devices described above (e.g., vehicular hologram apparatus 100, the server(s) 101, the client device 102, the vehicle 106, and the third-party server(s) 112). In one or more aspects, the computing device 900 may be a mobile device (e.g., a mobile telephone, a smartphone, a PDA, a tablet, a laptop, a camera, a tracker, a watch, a wearable device, etc.). In some aspects, the computing device 900 may be a non-mobile device (e.g., a desktop computer or another type of client device). Further, the computing device 900 may be a server device that includes cloud-based processing and storage capabilities.

As shown in FIG. 9, the computing device 900 can include one or more processor(s) 902, memory 904, a storage device 906, input/output interfaces 908 (or “I/O interfaces 908”), and a communication interface 910, which may be communicatively coupled by way of a communication infrastructure (e.g., bus 912). While the computing device 900 is shown in FIG. 9, the components illustrated in FIG. 9 are not intended to be limiting. Additional or alternative components may be used in other aspects. Furthermore, in certain aspects, the computing device 900 includes fewer components than those shown in FIG. 9. Components of the computing device 900 shown in FIG. 9 will now be described in additional detail.

In particular aspects, the processor(s) 902 includes hardware for executing instructions, such as those making up a computer program. As an example, and not by way of limitation, to execute instructions, the processor(s) 902 may retrieve (or fetch) the instructions from an internal register, an internal cache, memory 904, or a storage device 906 and decode and execute them.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 904 may be internal or distributed memory.

The computing device 900 includes a storage device 906 includes storage for storing data or instructions. As an example, and not by way of limitation, the storage device 906 can include a non-transitory storage medium described above. The storage device 906 may include a hard disk drive (HDD), flash memory, a Universal Serial Bus (USB) drive or a combination these or other storage devices.

As shown, the computing device 900 includes one or more I/O interfaces 908, which are provided to allow a user to provide input to (such as user strokes, taps, swipes, presses, etc.), receive output from, and otherwise transfer data to and from the computing device 900. These I/O interfaces 908 may include a mouse, keypad or a keyboard, a touch screen, camera, optical scanner, network interface, modem, other known I/O devices or a combination of such I/O interfaces 908. The touch screen can be activated with a stylus, actuator, or a finger.

The I/O interfaces 908 may include one or more devices for presenting output to a user, including, but not limited to, a graphics engine, a display (e.g., a display screen), one or more output drivers (e.g., display drivers), one or more audio speakers, and one or more audio drivers. In certain aspects, I/O interfaces 908 are configured to provide graphical data to a display for presentation to a user. The graphical data may be representative of one or more graphical user interfaces and/or any other graphical content as may serve a particular implementation.

The computing device 900 can further include a communication interface 910. The communication interface 910 can include hardware, software, or both. The communication interface 910 provides one or more interfaces for communication (such as, for example, packet-based communication) between the computing device and one or more other computing devices or one or more networks. As an example, and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI. The computing device 900 can further include a bus 912. The bus 912 can include hardware, software, or both that connects components of the computing device 900 to each other.

Any of the features, components, and/or parts, including the arrangements and configurations thereof shown in FIG. 9 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIG. 9.

The foregoing description, for purposes of explanation, used specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not intended to be exhaustive or to limit the examples to the precise forms disclosed.

It will be apparent to one of ordinary skill in the art that many modifications and variations are possible in view of the above teachings. Indeed, various inventions have been described herein with reference to certain specific aspects and examples. However, they will be recognized by those skilled in the art that many variations are possible without departing from the scope and spirit of the inventions disclosed herein. Specifically, those inventions set forth in the claims below are intended to cover all variations and modifications of the inventions disclosed without departing from the spirit of the inventions. The terms “including” or “includes” as used in the specification shall have the same meaning as the term “comprising.”

What is claimed is:

1. A system, comprising:
a hologram device securable adjacent to a window of a vehicle;
a global positioning system (GPS) sensor;
a controller communicatively coupled to the hologram device, the controller comprising:
a processor; and
a memory device storing computer-executable instructions that, when executed by the processor, cause the processor to:
identify geolocation data from the GPS sensor;
determine graphical content to display via the hologram device based on the geolocation data; and
display the graphical content via the hologram device.

2. The system of claim 1, further comprising a client device communicatively coupled to the controller, wherein the GPS sensor is positioned within the client device.

3. The system of claim 1, further comprising an image sensor communicatively coupled to the controller.

4. The system of claim 3, wherein the image sensor is a camera carried by the controller.

5. The system of claim 3, wherein the image sensor is a vehicle camera carried by the vehicle.

6. The system of claim 3, wherein:
the graphical content comprises a first display priority; and
the computer-executable instructions further comprise determining targeted graphical content to display based on an image from the image sensor, the targeted graphical content comprising a second display priority that overrides the first display priority.

7. The system of claim 6, wherein the targeted graphical content is based on alpha-numeric values of a license plate captured in the image.

8. The system of claim 1, wherein the graphical content comprises an image or a video.

9. The system of claim 1, wherein the computer-executable instructions further comprise generating a database of images and image data corresponding to the images.

10. An apparatus, comprising:
a hologram device;
a vehicle mount attachable to the hologram device; and
a power supply in electrical communication with the hologram device.

11. The apparatus of claim 10, wherein the vehicle mount comprises a suction cup configured to engage a vehicle window.

12. The apparatus of claim 11, wherein the suction cup is a first suction cup positionable on a first lateral side of the hologram device, and the vehicle mount further comprises:
a second suction cup positionable on a second lateral side of the hologram device opposite the first lateral side; and
a support bar extending between the first suction cup and the second suction cup and connected to the hologram device.

13. The apparatus of claim 10, wherein the vehicle mount comprises a stand, the stand being mountable to a vehicle support surface.

14. The apparatus of claim 10, wherein the vehicle mount comprises a vehicle frame mount to suspend the hologram device from a vehicle frame adjacent to a vehicle window.

15. The apparatus of claim 10, wherein the power supply comprises a vehicle power supply.

16. The apparatus of claim 10, wherein the apparatus further comprises a controller that includes a processor and a memory, the controller being communicatively coupled to the hologram device.

17. The apparatus of claim 16, wherein the controller comprises:
a window mount to attach the controller to a vehicle window; and
a camera to capture images through the vehicle window.

18. A method, comprising:
identifying a display trigger based on sensor data from a sensor;
retrieving graphical content to display according to the display trigger; and
presenting the graphical content for display via a hologram device, the hologram device being mountable to a window of a vehicle.

19. The method of claim 18, wherein:
the sensor comprises at least one of a global positioning system (GPS) sensor, an image sensor, or a motion sensor; and
the sensor data comprises at least one of geolocation data, image data, or vehicle motion data.

20. The method of claim 19, wherein identifying the display trigger comprises at least one of:
identifying, from the geolocation data, a current location corresponds to a certain geocoded area;
identifying, from the image data, a target audience is within a field of view of the image sensor; or
identifying, from the vehicle motion data, that the vehicle is either stopped or in transit.
